(19) United States
(12) Patent Application Publication
(10) Pub. No.: US 2011/0234917 A1
(43) Pub. Date: Sep. 29, 2011

(54) LIGHT SOURCE UNIT, LIGHTING DEVICE, DISPLAY DEVICE AND TELEVISION RECEIVER

(75) Inventor: Takahiro Yoshikawa, Osaka-shi (JP)

(73) Assignee: SHARP KABUSHIKI KAISHA, Osaka-shi, Osaka (JP)

(21) Appl. No.: 13/132,350

(22) PCT Filed: Nov. 5, 2009
(86) PCT No.: PCT/JP2009/068875

§ 371 Date: Jun. 2, 2011

(30) Foreign Application Priority Data
Dec. 26, 2008 (JP) 2008-333323

(51) Int. Cl. H04N 5/66; F21V 7/22; G02F 1/13357

(52) U.S. Cl. 348/739; 362/606; 349/62; 348/E05.133

(57) ABSTRACT

A light source unit, a lighting device, a display device and a television receiver configured to reduce deterioration of display quality are provided. The light source unit of the present invention includes light guide members 34. Each light guide member 34 includes a light guide portion 34B configured to guide incident light and a light exit portion 34A having a light exit surface 41 through which the incident light guided by the light guide portion 34B exits. The light exit portion 34A of one of the light guide members 34 is placed over the light guide portion 34B of another one of the light guide members 34. A reflection layer 50 is provided on a part of a surface of each light guide member 34 opposite from the light exit surface 41 from the light guide portion 34B to the light exit portion 34A. The reflection layer 50 is configured to reflect incident light to an inside of the other one of the light guide member 34. The reflection layer 50 is configured such that at least one of transmittance of light entering the light guide member 34 after entering the reflection layer and transmittance of light exiting the light guide member 34 after entering the reflection layer 50 is higher in an area located between the one of the light guide members 34 and the other one of the light guide members 34 than in another area.

### TECHNICAL FIELD

The present invention relates to a light source unit, a lighting device, a display device and a television receiver.

### BACKGROUND ART

A device disclosed in Patent Document 1 is known as a lighting device for a display device. The lighting device includes a light source unit, each of which includes light sources and light guide plates that are configured to pass incident light from the light sources and arranged in a grid. In the light source unit, the light sources are exclusively provided for the respective light guide plates. Therefore, the contrast can be enhanced by altering the brightness of each light source.

Patent Document 1: Japanese Published Patent Application No. 2002-72204

### Problem to be Solved by the Invention

More or less variations exist in performance or assembly work (or layout) of light sources and light guide members. In the above configuration in which each light guide member exclusively handles light from a designated light source, individual variability of the light sources directly affects performance of the lighting device. In such a case, even when the light sources arranged in an area where the light source unit is located are lit at the same luminous intensity, the individual variability of the light sources may directly affect the performance resulting in uneven brightness or color. When the individual variability of the light sources may directly affect the performance, display quality may decrease. Therefore, a solution for such a problem was needed.

### DISCLOSURE OF THE PRESENT INVENTION

The present invention was made in view of the foregoing circumstances. An object of the present invention is to provide a light source unit, a lighting device, a display device and a television receiver configured to reduce deterioration of display quality.

### Problem to be Solved by the Invention

To solve the above problem, a lighting source unit includes a plurality of light sources, a plurality of light guide members configured to guide incident light from the light sources, and reflection layers. Each light guide member includes a light guide portion and a light exit portion. The light guide members are arranged such that the light guide portion of one of the light guide members is placed over the light guide portion of another one of the light guide member. Each reflection layer is configured to reflect incident light toward an inside of a corresponding one of the light guide members. The light guide portion is configured to guide the incident light. The light exit portion is configured such that the incident light guided by the light guide portion exits through a light exit surface thereof. Each reflection layer is arranged in an area of a surface of the light guide member opposite from the light exit surface. The area is located from the light guide portion to the light exit portion. The reflection layer is configured such that at least one of transmittance of light entering the light guide member after entering the reflection layer and transmittance of light exiting the light guide member after entering the reflection layer is higher in an area located between the one of the light guide members and the other one of the light guide members than in another area.

With this configuration, light that leaks from the one of the light guide members passes through the reflection layer and enters the other one of the light guide members. The leak light is mixed with light that travels through the other one of the light guide members and the mixed light exits trough the light guide member. Even when variations are present between light exiting from the one of the light guide members and light exiting from the other one of the light guide members due to the variability due to individual variability of the light sources, the variations do not directly affect the light source unit. As a result, color uneveness due to the individual variability of the light sources does not occur and thus the display quality does not decrease.

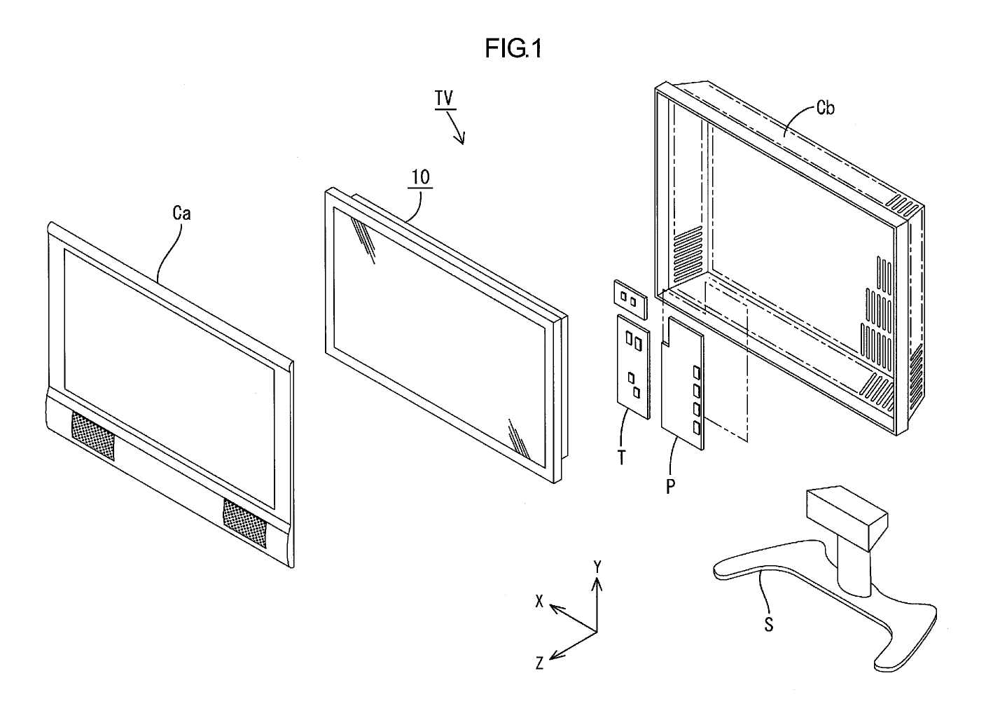

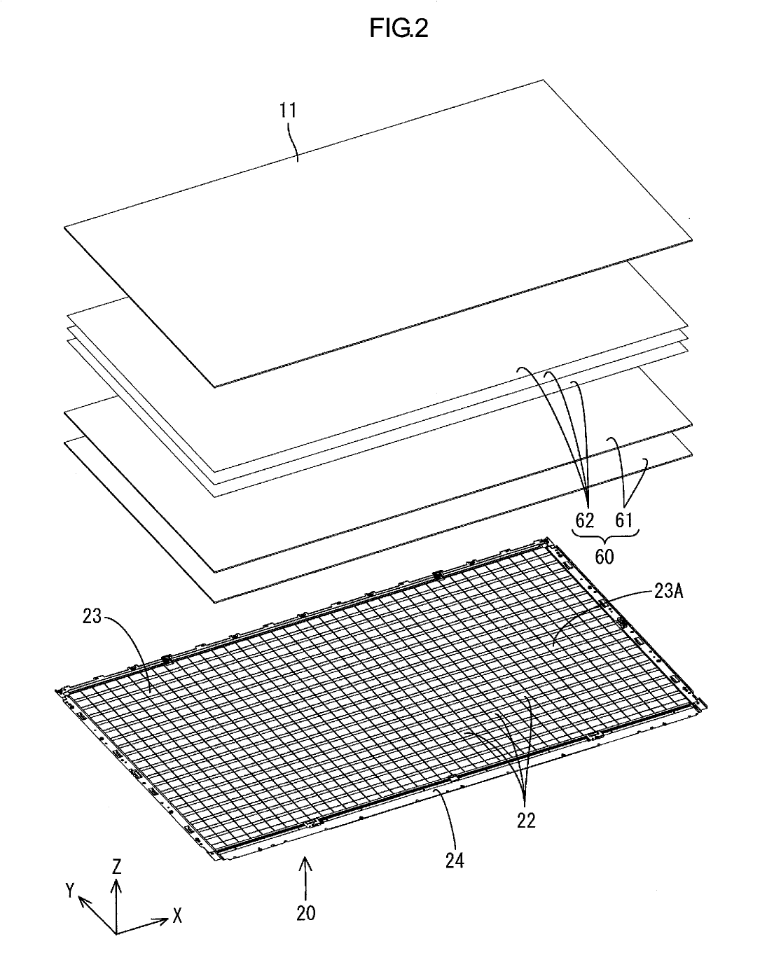

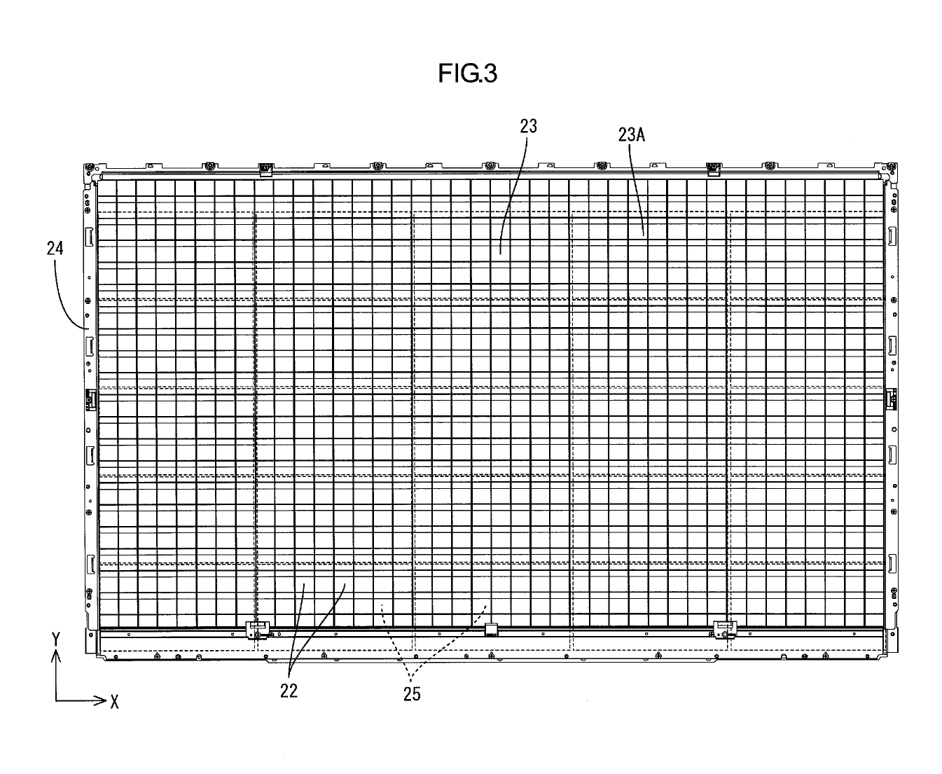

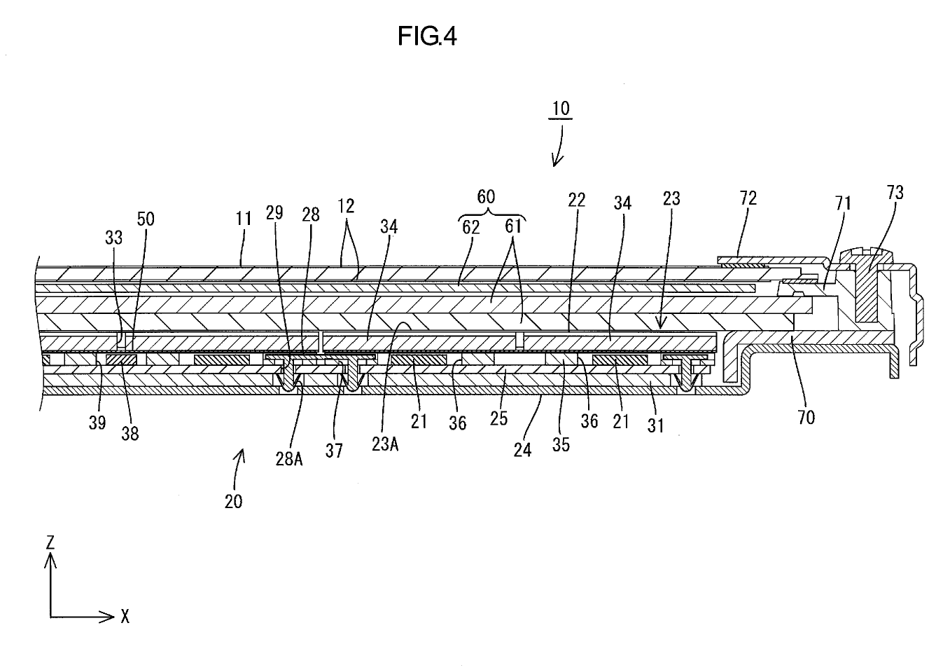

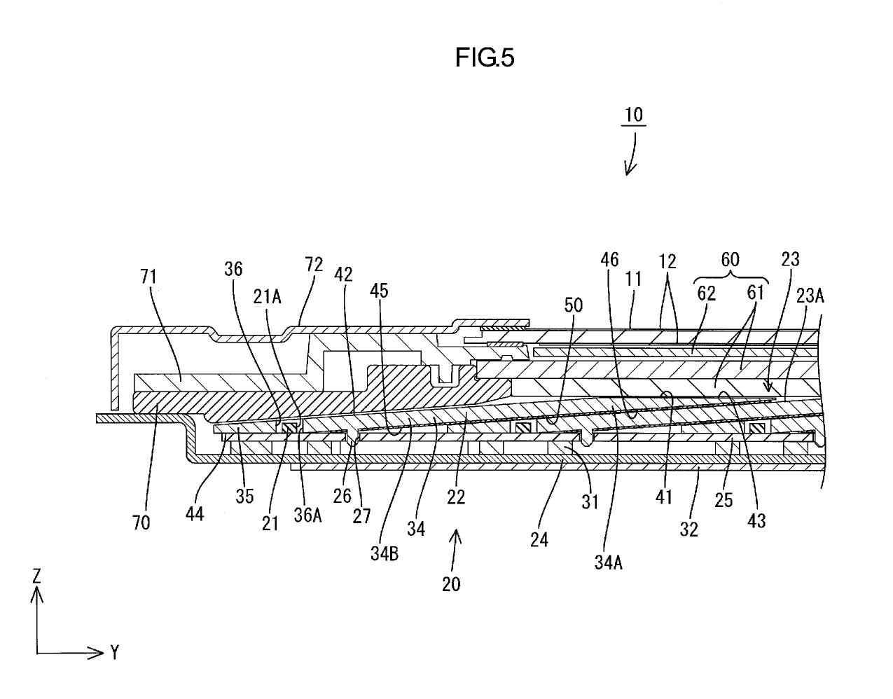

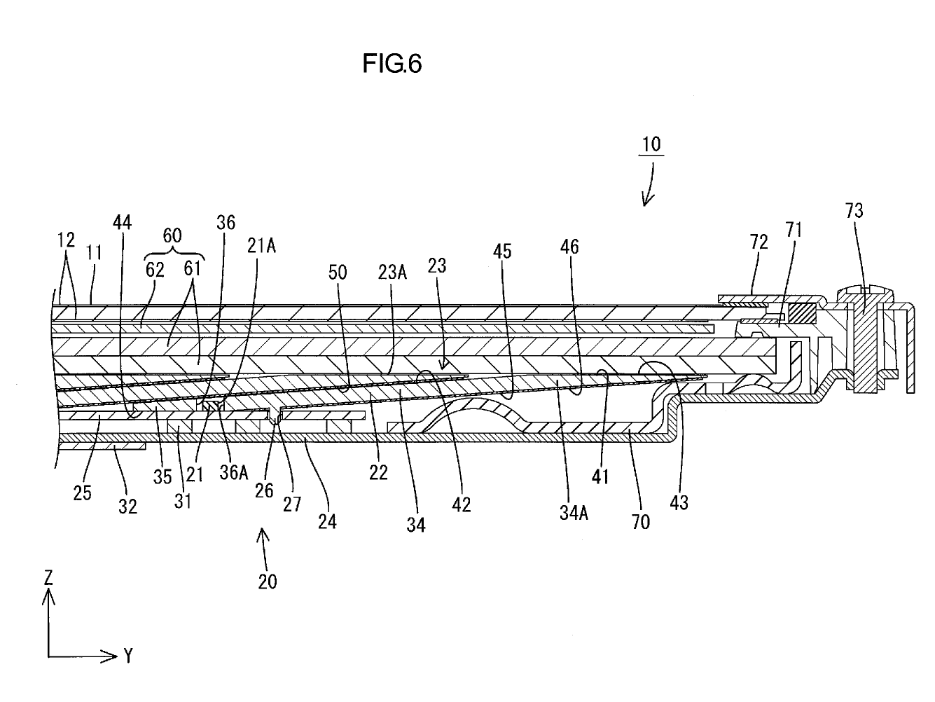

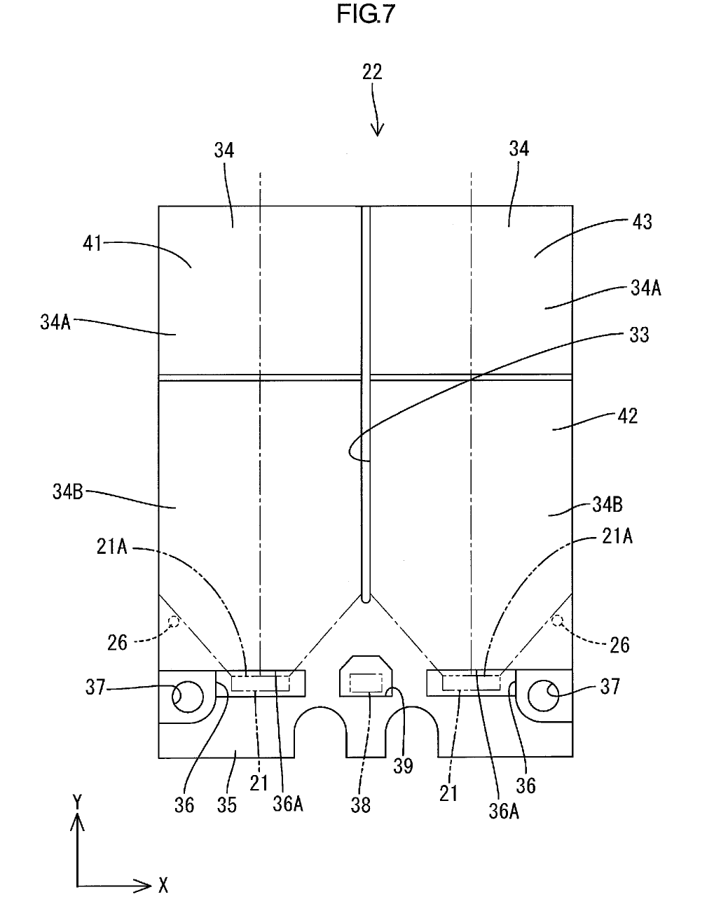

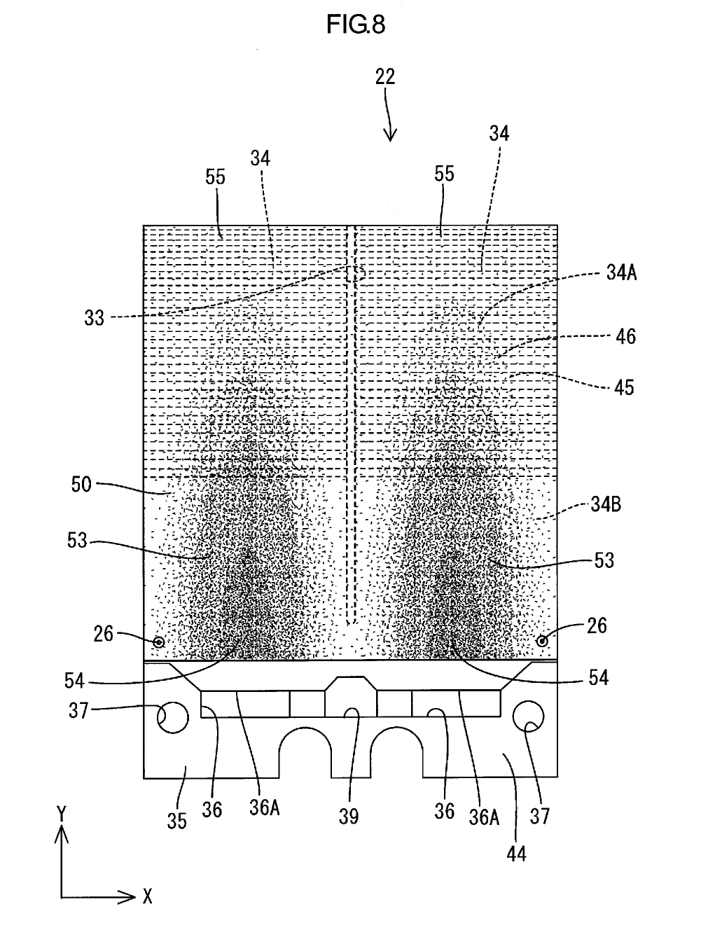

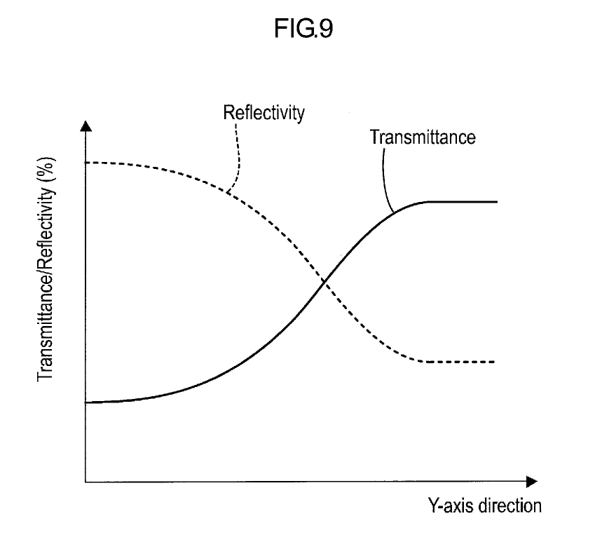

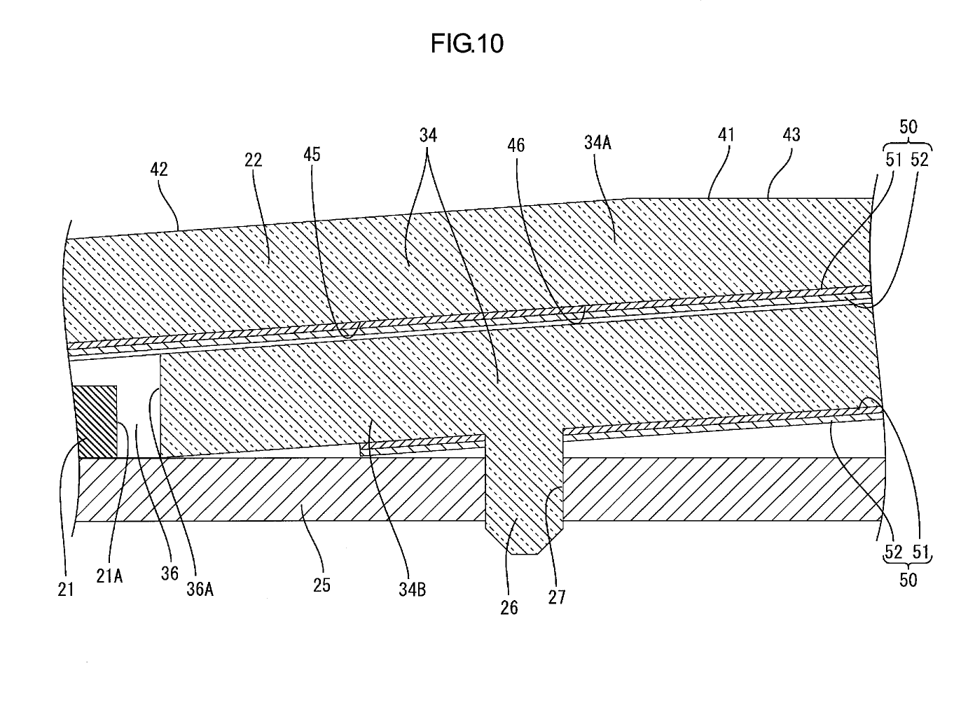

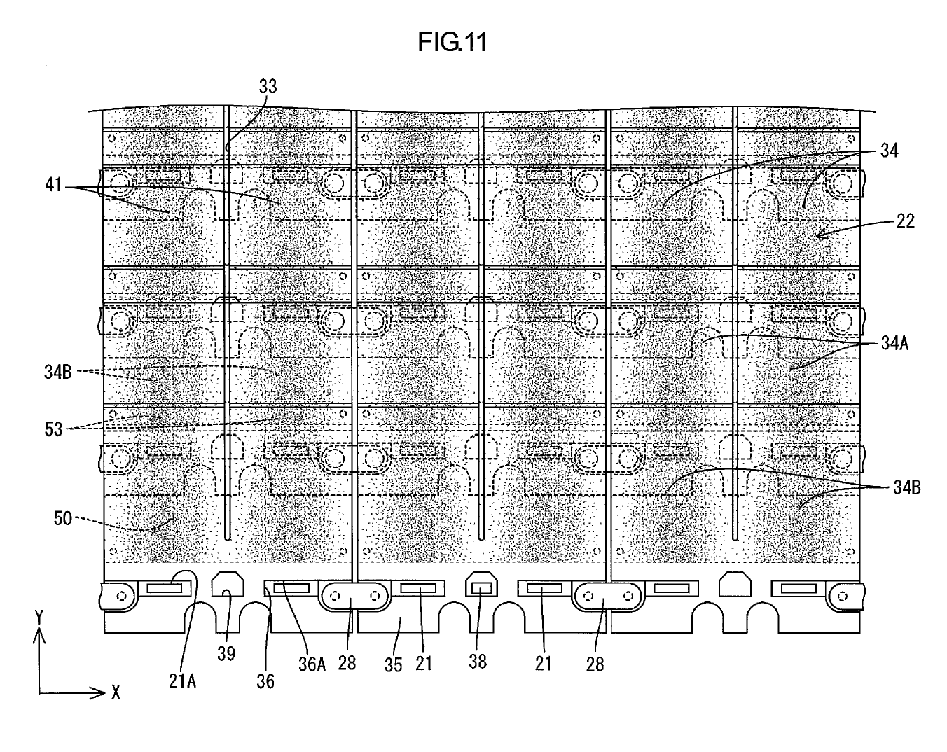

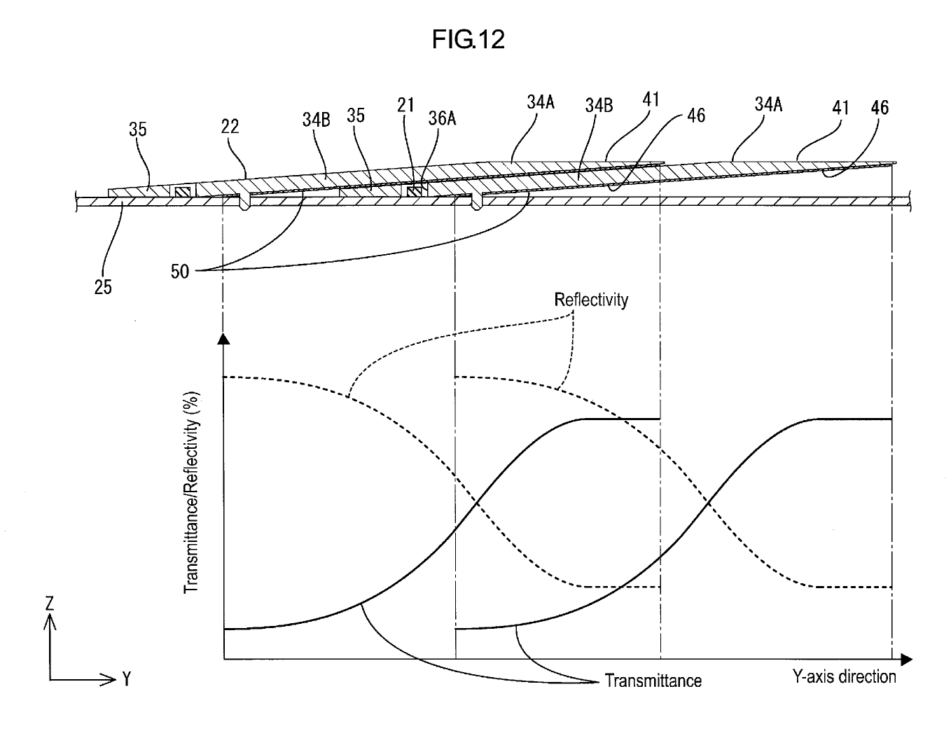

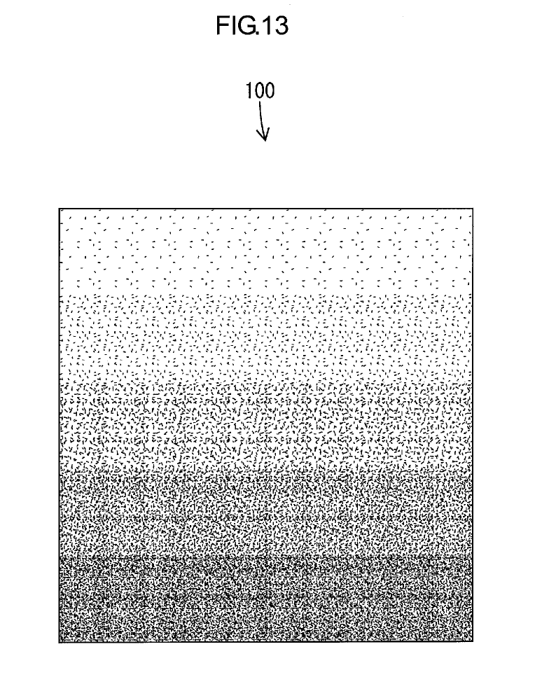

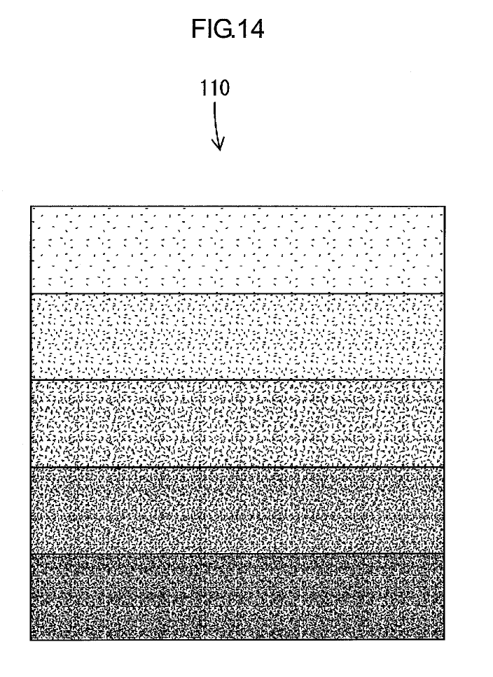

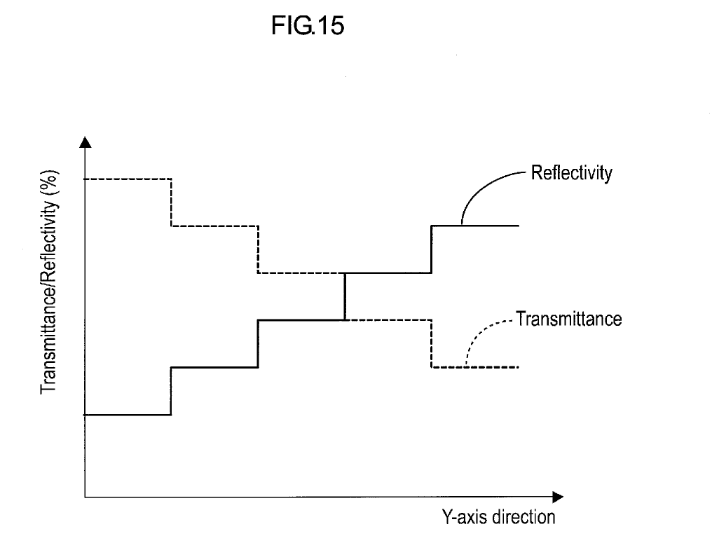

### BRIEF DESCRIPTION OF THE DRAWINGS

[FIG. 1] is an exploded perspective view illustrating a general construction of a television receiver according to an embodiment;

[FIG. 2] is an exploded perspective view illustrating a general construction of a liquid crystal display device;

[FIG. 3] is a plan view of a light source unit;

[FIG. 4] is a cross-sectional view of the liquid crystal display device around an end of the long side thereof;

[FIG. 5] is a cross-sectional view of the liquid crystal display device around an end of the short side thereof;

[FIG. 6] is a cross-sectional view of the liquid crystal display device around the other end of the short side thereof;

[FIG. 7] is a front view of a light guide plate;

[FIG. 8] is a rear view of a light guide plate;

[FIG. 9] is a chart illustrating variations in light transmittance and reflectivity of a reflection sheet;

[FIG. 10] is a magnified cross-sectional view of a part of the light source unit;

[FIG. 11] is a front view illustrating light guide plates in a parallel layout;

[FIG. 12] is a schematic view illustrating relationships between the light guide plates arranged so as to overlap each other in the front-to-rear direction and the variations in the light transmittance and reflectivity of the reflection sheet;

[FIG. 13] is a schematic view of a reflection layer according to an embodiment (6);

[FIG. 14] is a schematic view of a reflection layer according to an embodiment (7); and

[FIG. 15] is a chart illustrating variations in light transmittance and reflectivity of the reflection layer.

### BEST MODE FOR CARRYING OUT THE INVENTION

The first embodiment of the present invention will be explained with reference to FIGS. 1 to 12. In this embodiment, a liquid crystal display device 10 (a display device) will be explained. As illustrated in FIG. 1, the television receiver TV includes the liquid crystal display device 10 (a display device), cabinets Ca and Cb, a power source P, and a tuner T. The cabinets Ca and Cb sandwich the liquid crystal display device 10 therebetween. The liquid crystal display device 10 is housed in the cabinets Ca and Cb. The liquid crystal display device 10 is held by a stand S in a vertical position in which a display surface 11a is set along a substantially vertical direction (the Y-axis direction). In the following description, a lower left side of FIG. 1 (a front side of the television receiver TV, a display side) corresponds to a front side of each component, and an upper right side corresponds to a rear side of each component. An X-axis in the drawings indicates a direction parallel to the long side of the liquid crystal display device 10. A Y-axis in the drawings indicates a direction parallel to the short side of the liquid crystal display device 10. A Z-axis in the drawings indicates a direction parallel to the front-to-rear direction of the liquid crystal display device 10 (a positive side and a negative side correspond to the front side and the rear side, respectively).

The liquid crystal display device 10 has a landscape rectangular overall shape when viewed in the front-to-rear direction. As illustrated in FIG. 2, the liquid crystal display device 10 includes a liquid crystal panel 11 (an example of a display panel in claims) configured to display images and a backlight unit 20 (an example of a lighting device in claims), which is an external light source for illuminating the liquid crystal panel 11. The liquid crystal panel 11 and the backlight unit 12 are held together by a holding member such as a bezel 72.

The liquid crystal panel 11 includes a pair of transparent glass substrates (capable of light transmission) and a liquid crystal layer (not shown) having optical characteristics that change according to application of voltages. Each glass substrate is a landscape rectangular. The liquid crystal layer is provided between the substrates. Polarizing plates are attached to the front surface and the rear surface of the glass substrates, respectively (see FIGS. 4 to 6).

The backlight unit 20 is a so-called direct backlight 20 arranged closely behind the liquid crystal panel 11. The backlight unit 20 includes a light source unit 23 in which a plurality of LEDs 21 (an example of light sources in claims) and light guide plates 22 are arranged. The light guide plates 22 pass rays of light from the LEDs 21 therethrough.

The light source unit 23 includes a chassis 24 having a shallow tray shape that is recessed toward the rear (opposite from the liquid crystal panel 11). The chassis 24 is made of metal. A plurality of LED boards 25 are arranged on a bottom surface (the front surface) of the chassis 24. The LEDs 21, which are surface-mount type LEDs, are mounted on the LED boards 25.

Each LED board 25 is made of synthetic resin and the surface thereof is in white that provides high light reflectivity. The LED board 25 is a landscape rectangular when viewed in the front-to-rear direction. The LED boards 25 are arranged on the bottom surface of the chassis 24 with the longitudinal direction thereof aligned with the longitudinal direction of the chassis 24 (see FIG. 3) . About the entire bottom surface of the chassis 24 is covered with a plurality of the LED boards 25, specifically, five along the long side by five along the short side of the chassis 24 and a total of 25 LED boards 25.

Wiring patterns that are metal films are formed on each LED board 25 and the LEDs 21 are mounted in predetermined locations on the LED board 25. The LEDs 21 are arranged with predetermined pitches along the long-side direction and the short-side direction. Specifically, eight along the long side by four along the short side of the LED board 25 and a total of 32 LEDs 21 are arranged with predetermined pitches. The LED boards 25 are connected to a control board (not shown) . The control board is configured to control driving of the LEDs 21.

Each LED board 25 has positioning holes 27 in which positioning pins 26 of the light guide plate are fitted (see FIGS. 5 and 6). The LED board 25 also has clip lock holes 29 for attaching clips 28. The light guide plates 22 are fixed to the LED boards 25 with the clips 28 (see FIG. 4). The LED boards 25 are fixed to the bottom plate of the chassis 24 with screws, which are not shown.

Heat-transfer members 31 are provided between the LED boards 25 and the bottom surface (the front surface) of the chassis 24. Each heat-transfer member 31 is made of synthetic resin having high thermal conductivity or metal. A heatsink 32 made of synthetic resin having high thermal conductivity or metal is attached to the outer surface (the rear surface) of the chassis 24.

Each LED 21 has a block-like overall. The LED 21 is a side emitting LED, a side surface of which is a light-emitting surface 21A. The LED 21 is soldered to the LED board 25 with the long-side direction thereof aligned with the long-side direction of the LED board 25. Specifically, the LED 21 is mounted in a position that the light-emitting surface 21A is substantially perpendicular to the short side of the LED board 25 and to the front surface of the LED board 25. Moreover, the LED 21 is mounted in a position such that a light axis thereof is substantially parallel to the short side of the LED board 25 and to the front surface of the LED board 25. The LED 21 includes three different kinds of LED chips (not shown) with different main emission wavelengths. Specifically, each LED chip emits a single color of light of red (R), green (G) or blue (B).

A plurality of the light guide plates 22 are arranged on each LED board 25 so as to cover the front surface of the LED board 25. Each light guide plate 22 is made of substantially transparent (i.e., having high light transmission capability) synthetic resin (e.g. polycarbonate), a reflective index of which is significantly higher than that of air. The light guide plate 22 has a rectangular overall shape when viewed in the font-to-rear direction. The light guide plate 22 is arranged on the LED board 25 with the long-side direction aligned with the light axis of the LED 21.

As illustrated in FIG. 7, a slit 33 is formed so as to divide the light guide plate 22 along the long-side direction of the light guide plate 22 (at the middle of a short dimension of the light guide plate 22) . The slit 33 extends from one of ends of the long dimension of the light guide plate 22 toward the other end with one of ends thereof open and the other closed.

Each light guide plate 22 has unit light guide members 34 (an example of light guide members in claims) which are optically independent from each other. The unit light guide members 34 are formed on sides of the slit 33. Peripheral surfaces of each light guide member 34 are substantially perpendicular to the front surface of the LED board 25.

An area of each light guide plate 22 close to the other end of the long side (i.e., an area in which the slit is not formed) is a mounting portion 35 that is mounted to the LED board 25. Two unit light guide members 34 are connected via the mounting portion 35 and form a single light guide plate 22.

The mounting portion 35 has light source housing holes 36 in which the LEDs 21 are housed. The light source housing holes 36 are through holes that extend through the light guide plate 22 in the plate-thickness direction. Each light source housing hole 36 has a rectangular shape that is long in the short-side direction of the light guide plate 22. One of inner walls of the light source housing hole 36 facing the light-emitting surface 21A of the LED 21 is a light entrance surface 36A through which light from the LED 21 enters.

The light source housing holes 36 are located away from each other in the short-side direction of the light guide plate 22 with a predetermined gap therebetween. Each light source housing hole 36 is located around the center of the short dimension of the unit light guide member 34, that is, around the midpoint between the edge of the short dimension (i.e., the long side edge) of the light guide plate 22 and the slit 33. The light source housing hole 36 is formed in a location such that light from the LED 21 housed in the light source housing hole 36 does not enter the adjacent unit light guide member 34.

Each mounting portion 35 has clip insertion holes 37, which are through holes and in which the clips 28 are inserted for mounting the light guide plate 22 to the LED board 25. The clip insertion holes 37 are formed in portions near ends of the width of the mounting portion 35 (ends of the short dimension of the light guide plate 22). The clips 28 inserted in the clip insertion holes 37 are inserted in the clip lock holes 29 of the LED board 25. As a result, the light guide plate 22 is held in a mounting condition in which the light guide plate 22 is mounted to the LED board 25 (see FIG. 4).

As illustrated in FIGS. 4 and 11, each clip 28 is arranged across a boundary between the light guide plates 22 adjacently arrange in the X-axis direction. The clip 28 collectively fixes two adjacent light guide plates 22. The clip 28 includes elastic stoppers 28A. Each elastic stopper 28A touches an edge of the clip lock hole 29 and elastically deforms during insertion thereof in the clip lock hole 29. When the elastic stopper 28A is completely inserted in the clip lock hole 29, it returns to the original shape with resilience and locks to the rear surface of the LED board 25. By pushing the lamp clip 28 in the clip lock holes 29 via the clip insertion hole 37, that is, in a single step, the light guide plate 22 is fixed to the LED board 25.

Each mounting portion 35 has a sensor housing hole 39 in which a photo sensor 38 mounted on the LED board 25 is housed. The sensor housing hole 39 is located between the light source housing holes 36 (on an axial line of the slit 33).

Each unit light guide member 34 has a flat shape. It includes a light exit portion 34A and a light guide portion 34B. The light guide portion 34B guides incident light from the LED 21 to the light exit portion 34A and the light exits from the light exit portion 34A. A part of the unit light guide member 34 close to the light source housing hole 36 (one of ends of the plate surface) is the light guide portion 34B and a part away from the light source housing hole 36 (the other end of the plate surface) is the light exit portion 34A. The light emitted from the LED 21 enters the unit light guide member 34 through the light entrance surface 36A. The light is guided toward the light ext portion 34A. The light travels inside the light guide portion 34B while being reflected several times so as not to leak to the outside and exits from the light exit surface 41 (the front surface) of the light exit portion 34A. The mounting portion 35 and the light guide portions 34 of the unit light guide members 34 are non-luminescent portions.

A part of the front surface of the light guide plate 22 between an end of the mounting portion 35 and a middle of the light exit portion 34A is a front sloped surface 42 that gradually slants toward the front (so as to gradually separate from the front surface of the LED board 25) from the end of the mounting portion 35 to the middle of the light exit portion 34A. A part of the front surface of the light guide plate 22 between an end of the front sloped surface 42 and the distal end of the light exit portion 34A is a front flat surface 43 substantially parallel to the front surface of the LED board 25 (see FIGS. 5 and 6). The entire front surface of the light guide plate 22 is a smooth surface without asperities.

The surface of the light exit portion 34A among the surfaces of the unit light guide member 34 (a part of the front sloped surface 42 and the entire part of the front flat surface 43) is the light exit surface 41 of the unit light guide member 34. The light exit surface 41 of the unit light guide member 34 is a rectangular that is slightly long in the long-side direction of the light guide plate 22 when viewed in the front-to-rear direction.

A part of the rear surface of each light guide plate 22 corresponding to the mounting portion 35 is a rear flat surface 44 substantially parallel to the front surface of the LED board 25. A part of the end of the mounting portin 35 and the distal end of the light exit portion 34A is a rear sloped surface 45 that gradually slants toward the front (so as to gradually separate from the front surface of the LED board 25) (see FIGS. 5 and 6).

The rear surface of the light exit portion 34A among the rear surfaces of each unit light guide member 34 (the surface away from the light exit surface 41) is a scattering surface 46 configured to scatter light. By scattering light with the scattering surface 46, light rays strike the light exit surface 41 at the incident angles smaller than the critical angle so that total reflection at the light exit surface 41 is less likely to occur. The scattering surface 46 has microscopic asperities. Specifically, the scattering surface 46 has a plurality of holes that extend straight along the short-side direction of the unit light guide member 34. An arrangement pitch of the holes gradually decreases from the light guide portion 34B to the distal end of the light exit portion 34A (or to the upper side) (see FIG. 8). With this configuration, a difference in brightness between the part of the light exit surface 41 close to the LED 21 and the part away from the LED 21 is as small as possible so as to provide even brightness.

Each unit light guide member 34 has a positioning pin 26 that is inserted in the positioning hole of the LED board 25 for positioning the light guide plate 22 relative to the LED board 25.

Reflection sheets 50 (an example of a reflection layer in claims) are attached to the rear surfaces (the rear surfaces of the light guide plates 22) the unit light guide members 34, respectively. The reflection sheet 50 will be explained in detail later.

A plurality of the light guide plates 22 are arranged on the front surface of each LED board 25 such that the light exit surfaces 41 of the unit light guide members 34 are arranged along the planar direction (substantially parallel to the front surface of the LED board 25) without gaps therebetween. The light guide plates 22 are arranged on the front surface of the LED board 25 such that each light guide plate 22 is in an orientation that the mounting portion 35 is at the lower side (on the negative side of the Y-axis direction) and the light exit portion 34A at the upper side (on the positive side of the Y-axis direction) (see FIG. 11).

The light guide plates 22 are arranged in lines along the Y-axis direction. In each line, ends of the long dimensions of the light guide plates 22 overlap each other. The lines of the light guide plates 22 are away from each other in the X-axis direction with predetermined gaps. In each line, the light guide plates 22 are arranged such that the light exit portion 34A of one of the unit light guide member 34 is placed over the front surface of the light guide portion 34B of another one of the unit light guide member 34. Namely, the light exit portion 34A of one of the light guide plates 22 is placed over the front surfaces of the non-luminescent portions (the area from the mounting portion 35 to the light guide portion 34B) of another one of the light guide plates 22. The light exit surfaces 41 of the light guide plates 22 are arranged in lines along the Y-axis direction without gaps.

The light guide plates 22 arranged in lines along the Y-axis direction so as to overlap each other and the lines of the light guide plates 22 are away from each other in the X-axis direction with the predetermined gaps (in a size similar to the width of the slits 33). The lines of the light guide plates 22 are arranged so as not to overlap each other. The light exit surfaces 41 are arranged in lines along the Y-axis direction and the X-axis direction. Namely, the light exit surfaces 41 of the light guide plates 22 are arranged so as to cover a substantially entire surface of the LED board 25. The light exit surfaces 41 of all light guide members 34 in the light source unit 23 form the light exit surface 23A of the light source unit 23.

The backlight unit 20 includes an optical member 60 arranged on the front side (the light exit surface 41 side) of the light source unit 23. The optical member 60 includes two diffusers 61 and three optical sheets 62 (see FIG. 2). The diffusers 61 are provided for even brightness and arranged adjacent to the light exit surface 23A of the light source unit 23. The optical sheets 62 are arranged on the front side of the diffusers 61 (on the liquid crystal panel 11 side). The optical sheets 62 include a diffuser sheet, a lens sheet and a reflection-type polarizing sheet layered in this order from the rear.

A support member 70 for supporting entire edge portions of the diffusers 61 is arranged on edge portions of the chassis 24 (see FIG. 4). A frame 71 is provided between the edge portions of the diffusers 61 and edge portions of the liquid crystal panel 11. The edge portions of the diffusers 61 are sandwiched between the support member 70 and the frame 71. A bezel 72 is provided on the front of the edge portions of the liquid crystal panel 11. The edge portions of the liquid crystal panel 11 are sandwiched between the bezel 72 and the frame 71. The optical sheets 62 are held between the diffusers 61 and the liquid crystal panel 11.

The bezel 72, the frame 71 and the chassis 24 are held together with screws at a plurality of positions and the liquid crystal display device 10 is assembled (see FIGS. 4 and 6). As illustrated in FIG. 5, at the lower part of the liquid crystal display device 10, the support member 70 placed over the mounting portions 35 and the light guide portions 34B of the light guide plates 22. As illustrated in FIG. 4, at the upper part of the liquid crystal display device 10, the support member 70 is along the bottom plate of the chassis 24 and supports the distal end portions of the light guide plates 22 and the diffusers 61 from the rear.

Each reflection sheet 50 is arranged on a part of the rear surface of the light guide plate 22 excluding the mounting portion 35 (a part of each unit light guide member 34 from the light guide portion 34B to the light exit portion 34A) (see FIG. 8). The reflection sheet 50 is a rectangular slightly large in the vertical direction and an area thereof is about the same as an area of the rear surface of the light guide plate 22 from the light guide portions 34B to the light exit portions 34A of two unit light guide members 34. The reflection sheet 50 is overlaid entirely on the area of the rear surface of the light guide plate 22 from the light guide portions 34B to the light exit portions 34A (including the slit 33).

Each reflection sheet 50 includes unit reflection parts 53 corresponding to the unit light guide members 34, respectively (so as to be overlaid on the rear surfaces of the unit light guide members 34. Namely, the reflection sheet 50 includes integrally provided two unit reflection parts 53 arranged parallel to each other.

The reflection sheet 50 has a double-layered structure including a diffuse reflection layer 51 on the front (the panel side) and a specular reflection layer 52 on the rear (the chassis 24 side) (see FIG. 10).

The diffuse reflection layer 51 is a synthetic resin layer in white that provides high light reflectivity and configured to reflect rays of incident light into the diffuse reflection layer 51 in various directions (i.e. to scatter the rays).

The specular reflection layer 52 is a metal film evaporated on the rear surface of the diffuse reflection layer 51. In this embodiment, the specular reflection layer 52 is an evaporated aluminum film. The specular reflection layer 52 includes a part in which an amount of evaporated metal per unit area is large (hereinafter referred to as the metal amount) and part in which the amount is small. Namely, the specular reflection layer 52 has parts in different thicknesses. Specifically, apart of the specular reflection layer 52 in an area corresponding to the light guide portion 34B of the unit light guide member 34 is thick (the metal amount is large) and a part in an area corresponding to the light exit portion 34A is thin (the metal amount is small). The thickness (or the metal amount) of the specular reflection layer 52 gradually varies along the Y-axis direction. The thickness (or the metal amount) gradually decreases from the light guide portion 34B to the light exit portion 34A.

Each unit reflection part 53 has such a gradation. The gradation of the unit reflection part 53 and the gradation of the other unit reflection part 53 are line-symmetric with respect to the slit 33 of the light guide plate 22. Evaporation patterns of the metal can be in any shapes including dot patterns and line patterns. Dots in the dot patterns can be in any shape including round shapes, square shapes, rectangular shapes and polygonal shapes.

The part of the specular reflection layer 52 of the each unit reflection part 53 closest to the light entrance surface 36A of the unit light guide member 34 is a high-reflection portion 54. The metal amount of the low-reflection portion 55 is the smallest and the light reflectivity is the lowest.

The part of the specular reflection layer 52 of the each unit reflection part 53 farthest away from the light entrance surface 36A of the unit light guide member 34 is a low-reflection portion 55. The metal amount of the low-reflection portion 55 is the smallest and the light reflectivity is the lowest.

The metal amount of the specular reflection layer 52 gradually decreases from the center of the width of the unit reflection portion 53 to either side of the unit reflection portion 53 (ends on the positive side and the negative side in the X-axis direction). The gradation of the unit reflection part 53 is line-symmetric with respect to the centerline of the unit reflection part 53, which crosses the center of the width. The metal amount of the specular reflection layer 52 continuously varies.

By setting the metal amount of each specular reflection layer 52 so as to continuously vary, the light transmittance and reflectivity of each reflection sheet 50 continuously vary as illustrated in FIG. 9. FIG. 9 illustrates the light transmittance and reflectivity of the unit reflection part 53 measured at the center of the width.

The light transmittance of the reflection sheet 50 substantially follows the light transmittance of the specular reflection layer 52. The light transmittance of the specular reflection layer 52 indicates a percentage of light that exits from the rear surface of the specular reflection layer 52 out of light that enters the specular reflection layer 52 from the front surface and. The light transmittance of the specular reflection layer 52 also indicates a percentage of light that exits from the front surface of the specular reflection layer 52 out of light that enters the specular reflection layer 52 from the rear surface. The light transmittance of the specular reflection layer 52 measured for light that enters from the front and the light transmittance measured for light that enters from the rear are substantially equal.

The light transmittance of each reflection sheet 50 indicates a percentage of light that exits (the unit light guide member) from the rear surface of the reflection sheet 50 out of light that leaks from the unit light guide member 34 located on the front of the reflection sheet 50 and enters the reflection sheet 50. The light transmittance of each reflection sheet 50 also indicates a percentage of light that exits from the front surface of the reflection sheet 50 (and enters the unit light guide member 34 located on the front) out of light that leaks from the unit light guide member 34 located on the rear of the reflection sheet 50 and enters the reflection sheet 50.

The light transmittance of the reflection sheet 50 is higher in an area corresponding to the light exit portion 34A (an area overlapping the rear surface of the light exit portion 34A) than in other areas. Furthermore, the light transmittance of the reflection sheet 50 is the lowest in the high reflection portion 54 (the left end of the Y-axis in FIG. 9) and the highest in the low reflection portion 55 (the right end). The light transmittance of the reflection sheet 50 gradually and continuously varies (i.e., increases) from the high reflection portion 54 to the low reflection portion 55 (toward the positive side of the Y-axis). As illustrated in FIG. 12, the light transmittance in apart of the reflection sheet 50 located between the light exit portion 34A of one of the unit light guide member 34 (the unit light guide member 34 on the front in FIG. 12) and the light guide portion 34B of the other unit light guide member 34 (the unit light guide member 34 on the rear in FIG. 12) is the highest. The light transmittance gradually increases from the center of the width of the reflection sheet 50 to either side (the positive or the negative side of the X-axis).

The light reflectivity in a part of the reflection sheet 50 corresponding to the light guide portion 34B (the part overlapping the rear surface of the light guide portion 34B) is higher than the other areas. The light reflectivity of the reflection sheet 50 is the highest in the high reflection portion 54 (the left end of the Y-axis in FIG. 9) and the lowest in the low reflection portion 55 (the right end). The light reflectivity of the reflection sheet 50 gradually and continuously varies (i.e., decreases) from the high reflection portion 54 to the low reflection portion 55 (toward the positive side of the Y-axis). As illustrated in FIG. 12, the light reflectivity in a part of the reflection sheet 50 closest to the light entrance surface 36A of one of the unit light guide member 34 is the highest. The light reflectivity gradually decreases from the center of the width of the reflection sheet 50 to either side (the positive or the negative side of the X-axis).

Each reflection sheet 50 is attached to the rear surface of each light guide plate 22 with a transparent adhesive (not shown).

Next, functions and effects of this embodiment configured as above will be explained.

A plurality of the unit light guide members 34 are arranged such that the light exit portion 34A of one of the unit light guide members 34 is placed over the front surface of the light guide portion 34A of another one of the unit light guide members 34. The light exit portions 34A of the unit light guide members 34 and the light exit portions 34A of the other unit light guide members 34 are arranged without gaps. The reflection sheet 50 that reflects light is arranged on a part of the rear surface of each unit light guide member 34 from the light guide portion 34B to the light exit portion 34A. The light transmittance of each reflection sheet 50 is higher in the area corresponding to the light exit portion 34A than in the other areas.

With this configuration, most of the rays of light that leaks from the light guide portion 34 of one of the unit light guide members 34 pass through the reflection sheet 50 on the rear surface of the other unit light guide member 34 arranged adjacently on the front and enter the light exit portion 34A of the other unit light guide member 34. Then, they exit from the light exit portion 34A with other ray of light that passes through the other unit light guide member 34. The light from the unit light guide member 34 is mixed with the light that passes through the other unit light guide member 34 and the mixed light exits from the other unit light guide member 34. Therefore, even when the variability due to individual variability of the LEDs 21 in brightness or color and mounting condition of the LEDs 21 or the light guide plates 22 is present, the variability does not directly affect the unit light guide members 34. As a result, color uneveness due to the individual variability of the LEDs 21 does not occur and thus the display quality does not decrease.

Each reflection sheet 50 includes the high reflection part 54 having the lowest light transmittance located the light in the part of the unit light guide member 34 closest to the light entrance surface 36A through which light from the LED 21 enters. With this configuration, the light entering each unit light guide member 34 through the light entrance surface 36A is reflected toward the front (the inside of the light guide portion 34B) by the reflection sheet 50. Namely, the light entering the light guide portion 34B of the unit light guide member 34 is less likely to leak to the rear (out of the light guide portion 34B) and thus the loss of light can be reduced.

Furthermore, two unit light guide members 34 are integrally provided and form a single light guide plate 22. Two light guide members can be handled at a time. Therefore, the number of assembly steps can be reduced in comparison to light guide members that are separately provided.

### OTHER EMBODIMENTS

The present invention is not limited to the above embodiment explained in the above description. The following embodiments may be included in the technical scope of the present invention, for example.

(1) In the above embodiment, each specular reflection layer 52 is a metal film evaporated on the rear surface of the corresponding diffuse reflection layer 51. However, each specular reflection layer may be a metal foil (e.g., an aluminum foil) attached to the rear surface of the diffuse reflection layer.

(2) In the above embodiment, each reflection layer is the reflection sheet 50 including the diffuse reflection layer 51 and the specular reflection layer 52 that is evaporated on the rear surface of the diffuse reflection layer 51. However, the reflection layer may be directly evaporated on the rear surface of the light guide plate. Furthermore, the reflection layer may include two sheets, a diffuser sheet and an evaporated sheet on which metal is evaporated.

(3) In the above embodiment, each specular reflection layer 52 is an aluminum-evaporated layer. However, the specular reflection layer may be formed with any kind of metal evaporated thereon. For example, silver may be evaporated.

(4) In the above embodiment, the optical member 60 includes two components, the diffuser 61 and the optical sheet 62. However, the optical member may include any kinds of sheets suitable for the requirement.

(5) In the above embodiment, each reflection sheet 50 includes two unit reflection portions 53 that integrally provided. However, each reflection layer may include separate unit reflection portions (separated from each other).

(6) In the above embodiment, each reflection sheet 50 is configured such that the light transmittance thereof increases from the center of the width of each unit reflection portion 53 to either side. However, the light transmittance can be set at different levels as long as it is higher in the part corresponding to the light exit portion than the other parts. For example, a reflection layer 100 illustrated in FIG. 13 has the light transmittance that is constant in the width direction and different only in the Y-axis direction. The light transmittance and reflectivity of the reflection layer 100 continuously vary in the Y-axis direction similar to the reflection sheet 50 of the above embodiment.

(7) In the above embodiment, each reflection sheet 50 is configured such that the light transmittance and reflectivity thereof continuously vary. However, the reflection sheet 50 may be configured such that the light transmittance and reflectivity vary stepwise. The reflection sheet 50 may be configured such that the light transmittance and reflectivity vary stepwise by dividing the reflection layer into a plurality of regions and setting the light transmittance and reflectivity for each region. For example, as illustrated in FIGS. 15 and 16, a reflection layer 110 includes a plurality of evenly divided regions (five evenly divide regions), and the light transmittance and reflectivity are set at different levels (five levels) for the different regions.

1: A lighting source unit comprising:
a plurality of light sources;
a plurality of light guide members configured to guide incident light from the light sources, each of the light guide members including a light guide portion and a light exit portion, the light guide members arranged such that the light guide portion of one of the light guide members is placed over the light guide portion of another one of the light guide member; and
reflection layers, each of the reflection layers being configured to reflect incident light toward an inside of a corresponding one of the light guide members, wherein:
the light guide portion is configured to guide the incident light;
the light exit portion is configured such that the incident light guided by the light guide portion exits through a light exit surface thereof;
the each of the reflection layers is arranged in an area of a surface of the light guide member opposite from the light exit surface, the area being located from the light guide portion to the light exit portion, and configured such that at least one of transmittance of light entering the light guide member after entering the reflection layer and transmittance of light exiting the light guide member after entering the reflection layer is higher in an area located between the one of the light guide members and the other one of the light guide members than in another area.

2: The light source unit according to claim 1, wherein each of the reflection layers is configured such that the transmittance thereof decreases as a distance to the light source decreases.

3: The light source unit according to claim 1, wherein each of the reflection layers is configured such that the transmittance thereof continuously varies.

4: The light source unit according to claim 2, wherein each of the reflection layers is configured such that the transmittance thereof varies from an area close to the light source to another area along a direction in which light travels.

5: The light source unit according to claim 1, wherein the each of the reflection layers has a double-layered structure including a diffuse reflection layer on a front and a specular reflection layer on a rear.

6: The light source unit according to claim 5, wherein the specular reflection layer is a metal film evaporated to a rear surface of the diffuse reflection layer.

7: The light source unit according to claim 6, wherein the metal film is an aluminum-evaporated film.

8: The light source unit according to claim 6, wherein the metal film is a silver-evaporated film.

9: The light source unit according to claim 1, wherein each of the light guide member includes the light guide portion on one of sides of a plane thereof and the light exit portion on another one of the sides of the plane direction thereof.

10: The light source unit according to claim 1, wherein the surface of the light exit portion opposite from the light exit surface is a scattering surface configured to scatter the incident light.

11: The light source unit according to claim 1, wherein the plurality of the light guide members are integrally provided so as to form a single light guide plate.

12: The light source unit according to claim 11, wherein each of the reflection layers includes unit reflection portions corresponding to the respective light guide members and integrally provided.

13: A lighting device comprising:
the light source unit according to claim 1; and
an optical member arranged on a light-exit-surface side of the light source unit.

14: A display device comprising:
the lighting device according to claim 13; and
a display panel configured to provide display using light from the lighting device.

15: The display device according to claim 14, wherein the display panel is a liquid crystal panel including liquid crystals.

16: A television receiver comprising the display device according to claim 14.
